(19) United States
(12) Patent Application Publication
(10) Pub. No.: US 2022/0185181 A1
(43) Pub. Date: Jun. 16, 2022

(54) DEVICE AND METHOD FOR CONTROLLING OPERATION OF SIDE AND REAR VIEW WATCHING CAMERA MONITORING SYSTEM

(71) Applicants: Hyundai Motor Company, Seoul (KR); Kia Corporation, Seoul (KR)

(72) Inventors: Chang Woo Sohn, Seoul (KR); Byeong Kwan Kim, Hwaseong (KR); Heung Sun Bong, Seoul (KR); Soo Man Jung, Hwaseong (KR)

(21) Appl. No.: 17/381,606

(22) Filed: Jul. 21, 2021

(30) Foreign Application Priority Data
Dec. 16, 2020 (KR) 10-2020-0176575

(51) Int. Cl. B60R 1/00; B60R 25/24; B60R 25/01; H04N 7/18; H04N 5/63

(52) U.S. Cl. CPC B60R 1/00; B60R 25/24; B60R 25/01; B60R 2300/404; H04N 5/63; B60R 2300/8046; B60R 2300/70; H04N 7/18

(57) ABSTRACT

A device and a method for controlling an operation of a side and rear view watching camera monitoring system (CMS) are provided. The device for controlling an operation of a side and rear watching CMS includes a camera that is configured to capture side and rear images of a vehicle and a display that is configured to display the images captured by the camera. A controller is configured to determine an image-off signal of a user and turn the images of the display off when the image-off signal is applied and a certain period of time elapses. The controller receives the image-off signal of the user, maintains the display in an ON state for a preset time, and turns electric power of the display off.

### CROSS-REFERENCE TO RELATED APPLICATION

This application claims under 35 U.S.C. § 119(a) the benefit of priority to Korean Patent Application No. 10-2020-0176575 filed on Dec. 16, 2020, the entire contents of which are incorporated herein by reference.

### BACKGROUND

### (a) Technical Field

The present disclosure relates to a method for controlling an operation of a side and rear view watching camera monitoring system (CMS), and more particularly, to a method for controlling an operation of a side and rear view watching CMS, which performs a power off operation of a display located in a vehicle in response to a driving of the side and rear view watching CMS in consideration of convenience of a user.

### (b) Background Art

With the recent development of image acquisition and display techniques, a view securing device capable of replacing the existing side mirror for checking vehicle side and rear information, that is, a monitoring device allowing a driver to check side and rear image information acquired through a camera by displaying the side and rear image information on a display has been developed.

In a vehicle equipped with a vehicle side and rear view watching camera monitoring system (CMS), side cameras, which each have a small size and each capture images of the surroundings of the vehicle, are mounted on left and right side surfaces of the vehicle instead of the existing side mirrors. In addition, image signals acquired by the side cameras are processed and displayed on side displays of a vehicle interior, and a driver checks side and rear conditions of the vehicle through image information displayed on the display.

FIG. 1 illustrates a structure of the related art in which one integrally assembled body 10 is assembled to a vehicle to provide a vehicle side and rear view watching CMS. In addition, the body 10 includes a camera 14, a display 12, and a controller which are integrated components, and a camera housing 13 and a monitor housing 11 form one body 10.

When a vehicle of the related art equipped with the side and rear view watching CMS, when the vehicle is traveling, side and rear images of the vehicle are displayed on the display 12 to provide convenience of driving. However, when the vehicle is not traveling, and a driver exit intention of the vehicle, a driven enter intention of the vehicle, or a request for securing side and rear visibility of a driver is present, since the side and rear images of the vehicle are not displayed on the display 12 a driver's demand is not satisfied.

In other words, when a request signal for securing side and rear visibility is received from a driver in various situations as well as a situation in which the vehicle is traveling, a control method of displaying side and rear environments of the vehicle cannot be provided.

### SUMMARY

The present disclosure provides a device and a method for operating a side and rear view watching camera monitoring system (CMS), which determine a display-off condition to optimize a standby current consumed by the side and rear view watching CMS. In another aspect, the present disclosure provides a device and a method for operating a side and rear view watching CMS, which are capable of automatically switching to a display-off state in response to various conditions of a user.

Objectives of the present disclosure are not limited to the above-described objectives, and other objectives of the present disclosure, which are not mentioned, may be understood by the following description and also will be more apparently understood through exemplary embodiments of the present disclosure. Further, the objectives of the present disclosure may be implemented by means described in the appended claims and a combination thereof.

A device for controlling an operation of a side and rear view watching camera monitoring system (CMS) includes the following configuration. In an exemplary embodiment, the present disclosure provides a device for controlling an operation of a side and rear view watching CMS, which may include: a camera configured to capture side and rear images of a vehicle; a display configured to display the images captured by the camera; and a controller configured to determine an image-off signal of a user and turn the images of the display off when the image-off signal is applied, wherein the controller is configured to receive the image-off signal of the user, maintain the display in an ON state for a preset time, and turn electric power of the display off.

In addition, the image-off signal of the user may include whether a door lock input of a vehicle wireless key is applied, a folding input of the CMS or a vehicle stop state input. In another exemplary embodiment, when the door lock input of the vehicle wireless key is not present, the controller may maintain the display in the ON state for a first set time, and when a door opening is applied within the first set time, the controller may maintain the display in the ON state even after the first set time elapses. In addition, when the folding input of the CMS is present, the controller may be configured to switch the display to an OFF state after a second set time elapses. When the vehicle stop state input is present and a gear is shifted to a vehicle stop state, the controller may be configured to switch the display to an OFF state after a third set time elapses.

In an exemplary embodiment, the present disclosure provides a method of controlling an operation of a side and rear view watching camera monitoring system (CMS), which may include: determining an image-off signal of a user in an ON state of a display; when the image-off signal of the user is applied, maintaining the display in the ON state for a set time; switching the display to an OFF state after the set time elapses; and after the display is switched to the OFF state, determining whether an image-on signal of the user is input.

In addition, in the determining of the image-off signal of the user, the image-off signal of the user may include whether a door lock input of a vehicle wireless key is applied, a folding input of the CMS, or a vehicle stop state input. The switching of the display to the OFF state according to whether the door lock input of the vehicle wireless key is applied may include in an ignition (IGN) OFF state, determining whether a door locking request of the vehicle wireless key is input; when the door locking request of the vehicle wireless key is not input, maintaining, by a controller, the display in an ON state for a first set time; determining whether a door opening is applied within the first set time; and when the door opening is not applied within the first set time, switching the display to the OFF state after the first set time elapses.

The switching of the display to the OFF state according to the folding input of the CMS may include maintaining, by a controller, the display in the ON state for a second set time; and switching the display to the OFF state after the second set time elapses. In addition, the switching of the display to the OFF state according to the vehicle stop state input may include, in an IGN ON state, determining whether a gear is switched to a vehicle stop state; and when the gear is switched to the vehicle stop state, switching the display to the OFF state after a third set time elapses.

In addition, the switching of the display to the OFF state may further include displaying a message indicating the display being switched to the OFF state. In the determining whether the image-on signal of the user is input, after the display is switched to the OFF state, when an IGN ON request of the user, a door opening request, or a gear driving state change is applied, the display may be switched to the ON state.

### BRIEF DESCRIPTION OF THE DRAWINGS

The above and other features of the present disclosure will now be described in detail with reference to exemplary embodiments thereof illustrated in the accompanying drawings which are given hereinbelow by way of illustration only, and thus are not limitative of the present disclosure, and wherein:

FIG. 1 is a diagram illustrating a side and rear view watching camera monitoring system (CMS) attached to an outer surface of a vehicle according to the related art;

FIG. 2 is a block diagram illustrating a configuration of a device for controlling an operation of a side and rear view watching CMS according to the present disclosure;

FIG. 3 is a block diagram illustrating a configuration of a controller in the device for controlling an operation of a side and rear view watching CMS according to the present disclosure;

FIG. 4 is a flowchart illustrating a method of controlling an operation of a side and rear view watching CMS according to the present disclosure;

FIG. 5 is a flowchart illustrating a process of performing a display-off switching according to a vehicle starting condition in the method of controlling an operation of a side and rear view watching CMS according to the present disclosure;

FIG. 6 is a flowchart illustrating a process of performing a display-off switching in response to a folding request of the side and rear view watching CMS in the method of controlling an operation of a side and rear view watching CMS according to the present disclosure.

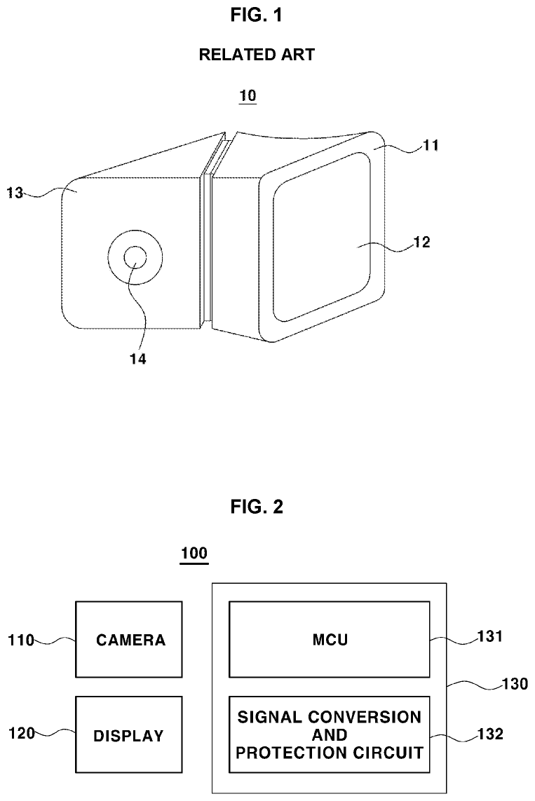

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings. The exemplary embodiments of the present disclosure can be modified in various forms, and the scope of the present disclosure should not be construed as being limited to the following exemplary embodiments. These exemplary embodiments are provided to more fully describe the present disclosure to those skilled in the art.

The term “˜part” used herein means a unit for processing at least one function or operation, and this unit may be implemented by hardware, software, or a combination of hardware and software. In addition, a vehicle wireless key disclosed in the specification and the drawings may be described as an “FOB.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

FIG. 2 illustrates a side and rear view watching CMS 100 according to one exemplary embodiment of the present disclosure, and the side and rear view watching CMS 100 includes a camera 110, a display 120, and a controller 130. The camera 110 of the present disclosure may include a movable lens (not shown) which is movable to vertical and lateral positions based on a central axis, and a direction of the movable lens is adjustable through a direction adjustment button (not shown) installed in a vehicle.

In addition, an upper end portion of a linear or round-shaped extension extending forward (to a rear side of the vehicle) may be formed on a case of the camera 110. Thus, the extension may serve as a shade or umbrella which protects the movable lens of the camera 110, thereby allowing a driver to secure a clear field of view irrespective of rain or snow, when the vehicle is traveling. In addition, side and rear images of the vehicle, which are captured by the camera 110, are provided to the driver through the display 120 located in the vehicle. As described above, since the display 120 of the present disclosure is located in the vehicle, the display 120 may be a component located in an A-pillar of the vehicle or on a window thereof.

The display 120 may be formed of a liquid crystal display (LCD), a light-emitting diode (LED), or an organic LED (OLED). More preferably, the display 120 of the present disclosure may be formed of an OLED which is inserted into an inner surface of an A-pillar or a door of the vehicle. In addition, since the controller 130 of the present disclosure displays the side and rear images received from the camera 110 on the display 120, an image display angle, an image display height or width may be set according to a user's request. When a failure occurs in the camera 110 or a connection component connected to the camera 110 of the vehicle, the controller 130 of the present disclosure may perform a fail-safe function.

In the device for controlling an operation of the side and rear view watching camera monitoring system 100 according to the present disclosure, the controller 130 may be configured to receive electric power through a battery integrally configured with the vehicle and a battery attached to the side and rear view watching CMS 100, and electric power for driving the side and rear view watching CMS 100 may be applied through a plurality of relays connected to the battery and configured to correspond to each component of the controller 130. The controller 130 may be configured to receive a door opening/closing state of the vehicle, a starting state thereof, and a door locking state thereof by being linked with a vehicle controller located in the vehicle and perform on/off control of the display 120.

According to the present disclosure, the CMS 100 is configured to automatically set a turning on/off of the display 120 through the controller 130 based on a state of the vehicle without separately having an on/off switch of the display 120.

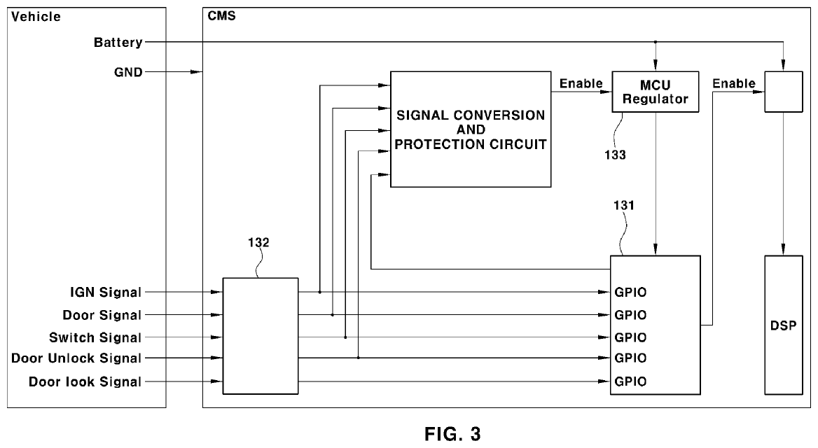

FIG. 3 illustrates a configuration of the controller 130 of the side and rear view watching CMS 100 according to the present disclosure. As one exemplary embodiment of the present disclosure, the side and rear view watching CMS 100 includes the controller 130, a micro control unit (MCU) 131, and a signal variation and protection circuit 132.

The signal variation and protection circuit 132 of the present disclosure may be configured to perform a function of receiving a plurality of signals generated from the vehicle, thereby receiving an ignition (IGN) signal, a vehicle door signal, a switching signal of the side and rear view watching CMS 100, and a vehicle door opening/closing signal. The received signals are transmitted to the MCU 131 through the signal variation and protection circuit 132.

In addition, in response to the signals transmitted to the MCU 131, the MCU 131 may be configured to operate a regulator of a digital signal processor (DSP) and the DSP. As described above, when the side and rear images are displayed on the display 120, a regulator of the side and rear view watching CMS 100 may be operated, electric power may be supplied to the side and rear view watching CMS 100 through the regulator, and image signals are processed. Thus, according to the user's request, the side and rear images may be displayed on the display 120. In addition, the plurality of received signals may be transmitted to an MCU regulator 133. When conditions of a smart key, an IGN signal, a door opening/closing signal, and a switching signal of the side and rear view watching CMS 100 are satisfied, the electric power is supplied to the MCU 131 to operate the side and rear view watching CMS 100.

In addition, as one exemplary embodiment of the present disclosure, a switch of the side and rear view watching CMS 100 is a component which is located in the vehicle and directly connects a user's request for securing side and rear visibility to the side and rear view watching CMS 100. Particularly, the switch connected to the side and rear view watching CMS 100 is a component which is maintained in an OFF state as a default value. To allow the user to operate the side and rear view watching CMS 100, the switch may be maintained in an OFF state, except when the switch is maintained in an ON state.

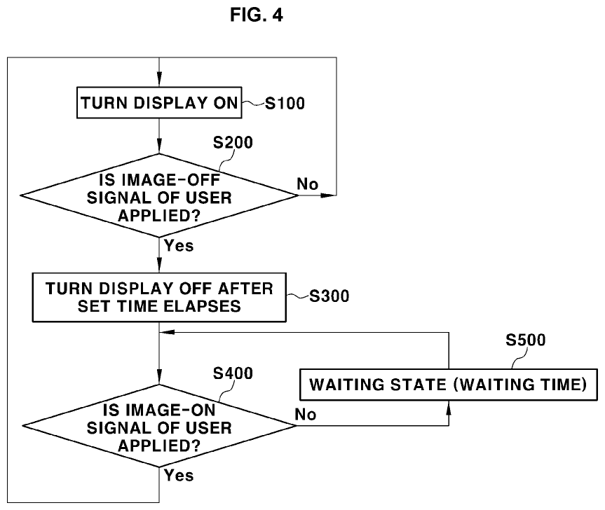

FIG. 4 is a flowchart illustrating a process of switching the display 120 to an OFF state in response to an image-off signal of the user, which is applied through the controller 130, according to an exemplary embodiment of the present disclosure. In an ON state of the display 120 of the vehicle, the controller 130 may be configured to determine whether the image-off signal of the user is received (S100).

In an operation of receiving the image-off signal, the controller 130 may be configured to determine a vehicle starting condition to determine whether a door lock input signal of a vehicle wireless key (FOB) is applied or a shift input of a gear to a stop state is applied. Particularly, when a vehicle stop state input is applied in an IGN ON state or a door lock input signal of the vehicle wireless key is received in an IGN OFF state, the controller 130 of the present disclosure may be configured to determine whether the display 120 is switched to the OFF state (S200).

In contrast, the controller 130 of the present disclosure may be configured to a folding input condition of the side and rear view watching CMS 100 regardless of an IGN condition. When the user applies a folding input of the side and rear view watching CMS 100, the controller 130 may be configured to determine whether the display 120 is switched to the OFF state. In other words, in the exemplary embodiment of the present disclosure, the application of the image-off signal by the user includes the door lock input of the vehicle wireless key, the folding input of the side and rear view watching CMS 100, or the a vehicle stop state input (S200).

When a signal determined based on the application of the image-off signal of the user is detected, the controller 130 may be configured to switch the display 120 to the OFF state after a set time elapses (S300). After the display 120 is switched to the OFF state, the controller 130 may be configured to determine whether the image-on signal of the user is applied, and in response to determining that the image-on signal is applied, the controller 130 may be configured to switch the display 120 to the ON state (S400). When the image-on signal of the user is not applied, the controller 130 may be configured to re-determine whether the image-on signal of the user is applied for a predetermined waiting time (S500).

Since the application of the image-on signal of the user may include an unfolding request signal of the CMS 100, when the unfolding request of the user with respect to the CMS 100 is applied, the controller 130 may be configured to switch the display 120 to the ON state. As described above, according to the present disclosure, even after the display 120 is switched to the OFF state, when the unfolding input of the CMS 100 is applied as an image-on signal application request of the user, the controller 130 may be configured to switch the display 120 to the ON state to provide a rear view to the user.

As described above, the controller 130 of the present disclosure may be configured to determine whether the image-off signal of the user is applied, and in response to determining that the image-off signal of the user is applied, the display 120 may be maintained in the ON state for a preset time and, after the preset time elapses, electric power of the display 120 may be turned off.

In addition, since the image-off signal of the user may be received by being linked with the vehicle controller located in the vehicle, the controller 130 may be configured to receive a vehicle door opening/closing state, determine whether the door lock input signal of the vehicle wireless key is applied, and receive a position of a gear. In summary, according to the present disclosure, since the display 120 which does not require a separate ON-OFF switch is provided, the controller 130 may be configured to automatically determine whether the electric power is applied to the display 120 in response to a state variation in the vehicle.

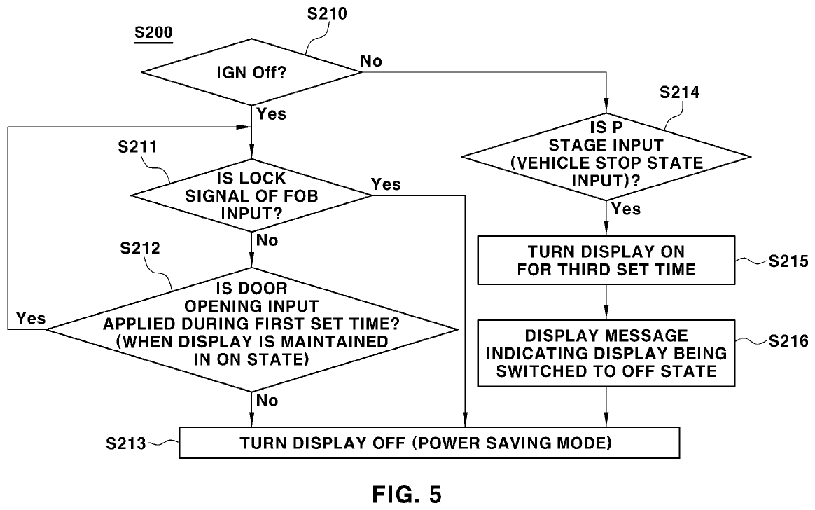

FIG. 5 is a flowchart illustrating a process of determining whether the image-off signal of the user is applied according to the IGN condition of the vehicle according to one exemplary embodiment of the present disclosure. To determine whether an image-off signal of a first user is applied, the controller 130 may be configured to determine an IGN state of the vehicle (S210). In the IGN OFF state of the vehicle, the controller 130 may be configured to determine whether a vehicle door lock signal (a lock signal) is input from the vehicle wireless key (S211). When the vehicle door lock signal is applied from the vehicle wireless key (S211), the controller 130 may be configured to immediately switch the display 120 to the OFF state (S213).

Otherwise, when the vehicle door lock signal is not applied from the vehicle wireless key (S211), the controller 130 may be configured to switch the display 120 to the ON state for a first set time and determine whether a door opening is input during the first set time (S212). When the door opening is not applied during the first set time, the controller 130 may be configured to switch the display 120 to the OFF state after the first set time elapses (S213). When the door opening is input during the first set time, the display 120 may be maintained in the ON state (S212), and the controller 130 may be configured to re-determine whether a lock signal of the vehicle wireless key is applied (S211). In the present disclosure, the first set time may be set to 120 seconds.

As described above, in an IGN OFF condition, since the controller 130 switches the display 120 to the OFF state in response to a door lock input condition of the vehicle wireless key, the controller 130 may be configured to determine a vehicle stop state input of a transmission in the IGN ON condition to determine whether the display 120 is switched to the OFF state. In the IGN ON state (S210), when a gear of the transmission is input to a P stage (S214), the controller 130 may be configured to maintain the display 120 in the ON state for a third set time (S215) and display a message indicating the display 120 being switched to the OFF state to the user (S216). As an example of the present disclosure, the third set time may be set to 600 seconds.

The message may be displayed through one or more among a cluster, a display, an Audio Video Navigation (AVN) display, and lighting of LED warning lights, which are located in the vehicle, and a message display method includes all visual or audible methods capable of transmitting the message to the user through the vehicle. Thereafter, the controller 130 may be configured to switch the display 120 to the OFF state (S213).

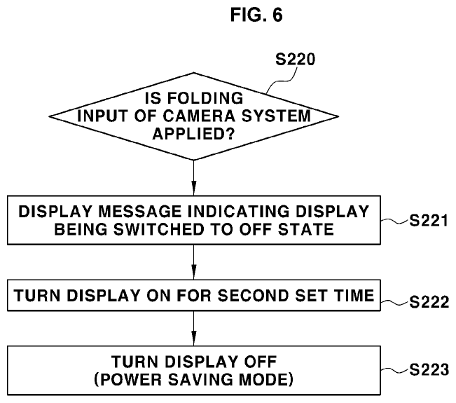

FIG. 6 is a flowchart illustrating a process of determining whether a folding input of the CMS 100 is applied and switching the display 120 to the OFF state according to another embodiment of the present disclosure. The controller 130 may be configured to determine whether the folding input of the CMS 100 is applied by the user (S220), and in response to determine that the folding input is applied, the controller 130 may be configured to transmit a display-off switching message (S221). However, when the folding input of the CMS 100 is not applied, the display 120 may be to be maintained in the ON state (S100). The controller 130 may be configured to transmit the display-off switching message (S221), switch the display 120 to the ON state for a second set time (S222), and then switches the display 120 to the OFF state (S223). More preferably, the second set time may be set to about five seconds.

As described above, the controller 130 may be configured to determine a starting condition (IGN state) of the vehicle and determine the door lock input of the vehicle wireless key or a vehicle stop input condition to switch the display 120 to the OFF state or may be configured to determine whether the folding request of the CMS 100 is applied to switch the display 120 to the OFF state. Therefore, it may be possible to provide a device and a method for controlling an operation of a side and rear view watching CMS, which are capable of reducing a power consumption rate applied to the display 120.

The present disclosure may obtain the following effects according to a combination of the above-described exemplary embodiments and a configuration, which will be described below, and a use relationship. In accordance with the present disclosure, there is has an effect of optimizing current consumption of a camera monitoring system (CMS) according to various environments through a device and a method for controlling an operation of a side and rear view watching CMS. In addition, in accordance with the present disclosure, there is an effect of providing a display control technique capable of satisfying regulations of the CMS based on a user scenario.

While the exemplary embodiments of the present disclosure have been described with reference to the accompanying drawings, a person skilled in the art to which the present disclosure pertains may understand that the present disclosure can be implemented in other specific form without departing from the technical spirit and essential features of the present disclosure. Therefore, it should be understood that the above-described embodiments are not restrictive but illustrative in all aspects.

What is claimed is:

1. A device for controlling an operation of a side and rear view watching camera monitoring system (CMS), comprising:
a camera configured to capture side and rear images of a vehicle;
a display configured to display the side and rear images captured by the camera; and
a controller configured to determine an image-off signal of a user and turn the images of the display off when the image-off signal is applied,
wherein the controller is configured to receive the image-off signal of the user, maintain the display in an ON state for a preset time, and turn electric power of the display off.

2. The device of claim 1, wherein the image-off signal of the user includes whether a door lock input of a vehicle wireless key is applied, a folding input of the CMS, or a vehicle stop state input.

3. The device of claim 2, wherein, when the door lock input of the vehicle wireless key is not present, the controller is configured to maintain the display in the ON state for a first set time, and when a door opening is applied within the first set time, the controller is configured to maintain the display in the ON state even after the first set time elapses.

4. The device of claim 2, wherein, when the folding input of the CMS is present, the controller is configured to switch the display to an OFF state after a second set time elapses.

5. The device of claim 2, wherein, when the vehicle stop state input is present and a gear is shifted to a vehicle stop state, the controller is configured to switch the display to an OFF state after a third set time elapses.

6. A method of controlling an operation of a side and rear view watching camera monitoring system (CMS), comprising:
determining, by a controller, an image-off signal of a user in an ON state of a display;
when the image-off signal of the user is applied, maintaining, by the controller, the display in the ON state for a set time;
switching, by the controller, the display to an OFF state after the set time elapses; and
after the display is switched to the OFF state, determining, by the controller, whether an image-on signal of the user is input.

7. The method of claim 6, wherein, in the determining of the image-off signal of the user, the image-off signal of the user includes whether a door lock input of a vehicle wireless key is applied and, a folding input of the CMS, or a vehicle stop state input.

8. The method of claim 7, wherein the switching of the display to the OFF state according to whether the door lock input of the vehicle wireless key is applied includes:
in an ignition (IGN) OFF state, determining, by the controller, whether a door locking request of the vehicle wireless key is input;
when the door locking request of the vehicle wireless key is not input, maintaining, by the controller, the display in an ON state for a first set time;
determining, by the controller, whether a door opening is applied within the first set time; and
when the door opening is not applied within the first set time, switching, by the controller, the display to the OFF state after the first set time elapses.

9. The method of claim 7, wherein the switching of the display to the OFF state according to the folding input of the CMS includes:
maintaining, by the controller, the display in the ON state for a second set time; and
switching, by the controller, the display to the OFF state after the second set time elapses.

10. The method of claim 7, wherein the switching of the display to the OFF state according to the vehicle stop state input includes:
in an IGN ON state, determining, by the controller, whether a gear is switched to a vehicle stop state; and
when the gear is switched to the vehicle stop state, switching, by the controller, the display to the OFF state after a third set time elapses.

11. The method of claim 10, wherein the switching of the display to the OFF state further includes displaying, by the controller, a message indicating the display being switched to the OFF state.

12. The method of claim 6, wherein, in the determining whether the image-on signal of the user is input, after the display is switched to the OFF state, when an IGN ON request of the user, a door opening request, or a gear driving state change is applied, the display is switched to the ON state.
